(19) United States
(12) Patent Application Publication
(10) Pub. No.: US 2024/0259470 A1
(43) Pub. Date: Aug. 1, 2024

(54) SEGREGATED ARCHITECTURE FOR FORECOURT CONTROL AND THE LIKE

(71) Applicant: Allied Electronics, Inc., Bristol, PA (US)

(72) Inventors: Robert E. Tomenchok, Jr., Lambertville, NJ (US); Louis Noah Seitchik, San Diego, CA (US)

(73) Assignee: Allied Electronics, Inc., Bristol, PA (US)

(21) Appl. No.: 18/348,508

(22) Filed: Jul. 7, 2023

Related U.S. Application Data
(60) Provisional application No. 63/482,605, filed on Feb. 1, 2023.

(51) Int. Cl. H04L 67/125

(52) U.S. Cl. CPC H04L 67/125

(57) ABSTRACT

A serial appliance for a forecourt control system has serial interfaces configured to support deterministic communications with deterministic, forecourt devices using specific device protocols; a network interface configured to support event-driven communications with one or more event-driven, network devices that are agnostic of the specific device protocols; and a processor configured to bridge the deterministic and event-driven communications. The serial appliance enables an event-driven portable controller to control the forecourt devices at a logical level by converting device-agnostic event-driven communications from the portable controller into device-gnostic deterministic communications with the forecourt devices. In some applications, a single portable controller can be connected to two or more co-located or remotely located serial appliances to control two or more different sets of forecourt devices. Analogous serial appliances can be employed in other segregated architectures for applications other than forecourt control.

### CROSS-REFERENCE TO RELATED APPLICATIONS

This application claims the benefit of the filing date of U.S. provisional application No. 63/482,605, filed on Feb. 1, 1923, the teachings of which are incorporated herein by reference in their entirety.

### BACKGROUND

### Field of the Disclosure

The present disclosure relates to forecourt controllers for gas stations and the like but also has application in other segregated architectures.

### Description of the Related Art

This section introduces aspects that may help facilitate a better understanding of the disclosure. Accordingly, the statements of this section are to be read in this light and are not to be understood as admissions about what is prior art or what is not prior art.

In retail stores that sell fuel (including, but not limited to, gas stations, truck stops, convenience stores, big-box retailers, military base exchanges), the forecourt is located outside of the store's structure and includes some or all of the following equipment:
AFDs (automated fuel dispensers);
Payment terminals, either stand-alone or integrated into the AFDs, each of which accepts payments and provides a display, a keypad, and a printer;
Fuel tanks, ATGs (automated tank gauges), and ATG controllers;
Car washes and car wash controllers;
RFID (radio frequency identification) antennae and RFID controllers;
Electronic price signs and price sign controllers; and
Leak detection systems.

Residing inside the store are systems providing POS (Point of Sale), BO (Back Office), EPS (Electronic Payment Services), and other business functions. Some or all of those “inside” systems need to communicate with the “outside” forecourt devices. This communication is typically performed via a forecourt controller (FCC).

FIG. 1 is a block diagram of a conventional forecourt control system 100 according to the prior art. At the heart of the system 100 is a forecourt controller (FCC) 102 that orchestrates the operations of the “outside” forecourt devices and the “inside” network systems. In particular, the FCC 102 has appropriate protocol drivers 102f, 102g, and 102h to communicate with the forecourt devices, such as one or more fuel dispensers 104, one or more corresponding dispenser payment terminals 106, a car wash controller 108, a tank gauge 110, and a price sign controller 112, via corresponding serial interfaces 103. In addition, the FCC 102 has a point-of-sale interface manager 102a to communicate with the “inside” network systems, such as a point-of-sale system 114, a non-fuel sales system 116, business information systems 118, and a cloud-based credit host 120, via a TCP-IP-based local area network (LAN) 122. To support those operations, the FCC 102 has command-and-control logic 102b, a dispenser pool 102d, and a payment terminal pool 102e, and maintains transaction records 102c.

The FCC 102 is a computer system running on its own hardware, connected to the store's LAN 122, communicating via, e.g., the TCP/IP (Transmission Control Protocol/Internet Protocol) protocol with the in-store network systems, and using legacy serial communications (e.g., RS-232, RS-485, current loop, and/or other proprietary interfaces) to communicate with the forecourt devices. As the next generation of forecourt devices evolves, some of those legacy serial interfaces are being replaced by TCP/IP.

Forecourt controllers originated out of a need to control fuel dispensers from inside the gas station. The first FCCs were developed by the same companies that manufactured fuel dispensers. Over time, other companies entered the marketplace.

First-generation FCCs allowed fuel dispensers to be authorized, prices to be changed, and transactional data to be collected from the dispensers and accessed inside the store. RS232 or some other serial communication interface connected the FCC to the POS.

Second-generation FCCs added communication to devices such as outside payment terminals and ATG controllers. Integrating outside payment terminals allowed customers to complete their fuel transaction (provide payment, dispense fuel, and print receipt) without going into the store. Integrating ATG controllers allowed store managers to monitor tank inventory without manually accessing the fuel tank, the ATG, or the ATG controller.

Third-generation FCCs integrated EPS functions, making the FCC the gateway to payment processors. Further, the interface between the business processes inside the store and the FCC migrated from serial to TCP/IP.

FCCs typically require some proprietary hardware, because the custom serial interfaces presented by forecourt devices are not supported in COTS (Consumer Off-The-Shelf) hardware. While early FCCs used completely proprietary software (operating system and applications), modern systems often combine an OS (operating system), such as a Linux OS or an Embedded Windows OS, with custom applications.

The state-of-the-art FCC is nominally a high-performance, embedded, real-time computer with “closely coupled” peripheral interfaces in which the “communications stack” resides wholly within the confines of the device.

The communications stack represents the mechanism through which data are conveyed to and from the peripheral equipment, where the communication stack defines, for example, application message construction, error correction, serialization/de-serialization, packet/frame construction, et cetera.

Payment terminals, whether in-dispenser (i.e., one terminal per dispenser) or stand-alone (i.e., one terminal for one or more dispensers) have largely migrated from legacy low-speed serial interfaces to TCP/IP.

The rationale behind this migration is two-fold: (i) security of the cardholder data can be assured through the use of encryption and (ii) the increased sophistication of the user interface dictates the increased bandwidth found in TCP/IP.

Other peripherals such as the dispensers, price sign controllers, tank gauges, and carwash controllers mostly still rely on low-speed serial interfaces using their proprietary protocols.

Serial devices often share a common bus in a Master/Slave relationship, where the master node is the FCC and the slaves are typically devices like dispensers or legacy payment terminals which are polled repeatedly. Master nodes initiate communications and arbitrate the bus; slave nodes are response-only devices. Multiple buses or “loops” of devices are encountered in a typical installation, each of which are managed in real-time.

At the same time, the FCC services the “command and control” aspects, essentially implementing the transaction steps and business rules associated with the commerce.

The interface between the data flowing into and out of the peripheral devices and the overall “command and control” of the commerce is carried out through internal data conveyance and synchronization mechanisms provided by the operating system within the traditional FCC.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a block diagram of a conventional forecourt control system according to the prior art;

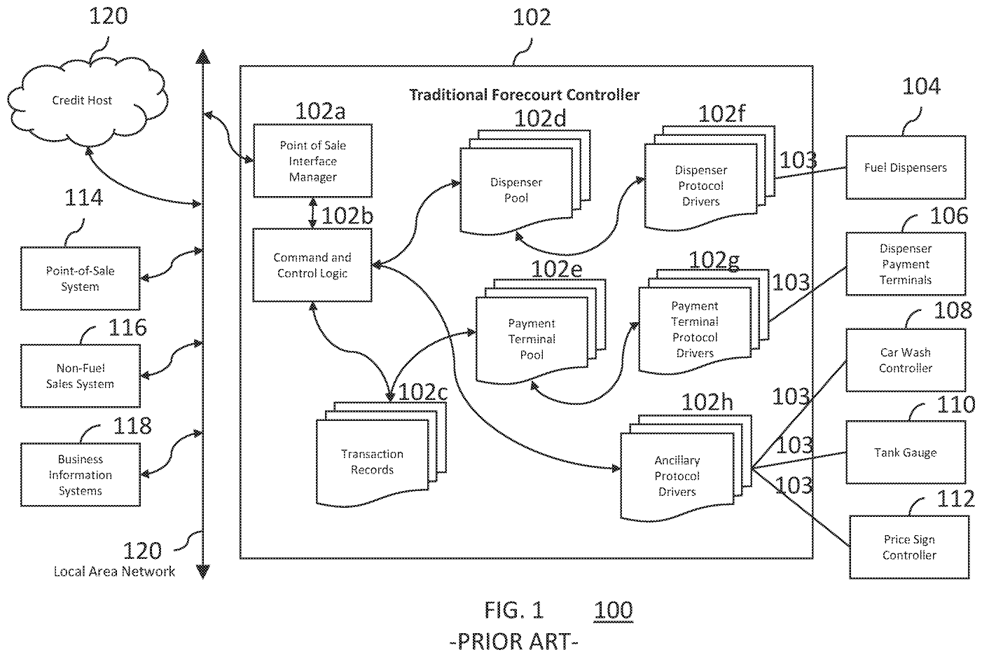

FIG. 2 is a block diagram of a forecourt control system according to one embodiment of the disclosure;

FIG. 3 is a hardware block diagram of the serial appliance of FIG. 2 according to one possible implementation;

FIG. 4 is a block diagram of the overall architecture of a serial appliance according to one embodiment of the disclosure;

FIG. 5 is a block diagram illustrating the handling of device-specific messages by the serial appliance of FIG. 4;

FIG. 6 is a block diagram illustrating the polling of dispensers by the serial appliance of FIG. 4;

FIG. 7 is a block diagram illustrating the processing of a dispenser command by the serial appliance of FIG. 4;

FIG. 8 is a block diagram illustrating the processing of commands for devices other than dispensers by the serial appliance of FIG. 4;

FIG. 9 is a block diagram representing a deployment of a portable controller and the serial appliance of FIG. 4 in which the portable controller is hosted on a computer housed locally;

FIG. 10 is a block diagram representing a deployment of a portable controller and the serial appliance of FIG. 4 in which the portable controller is hosted in the “Cloud”;

FIG. 11 is a block diagram of a forecourt control system according to an alternative embodiment of the disclosure;

FIG. 12 is a block diagram of a forecourt control system according to another alternative embodiment of the disclosure.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

The general trend of the dispenser and payment terminal manufacturers has been to view the dispenser and payment sub-systems as a composite system with the goal of greater integration. In contrast, the present approach segregates the dispenser and payment sub-systems to take advantage of the benefits of scaling appropriately the real-time components and provides the “command and control” in a virtual sense—i.e., functionality irrespective of the automation platform.

In one embodiment, the functionality of a traditional FCC will be separated into two components: a portable controller and one or more serial appliances. The serial appliance will provide a physical presence to access the serial forecourt devices-which allows the controller to be “portable”. As used herein, the term “portable” means that the controller does not necessarily have to reside within the same piece of hardware as the serial appliance. The internal data conveyance and synchronization mechanisms found in the traditional FCC will be replaced by a well-defined protocol communicated through a TCP/IP interface.

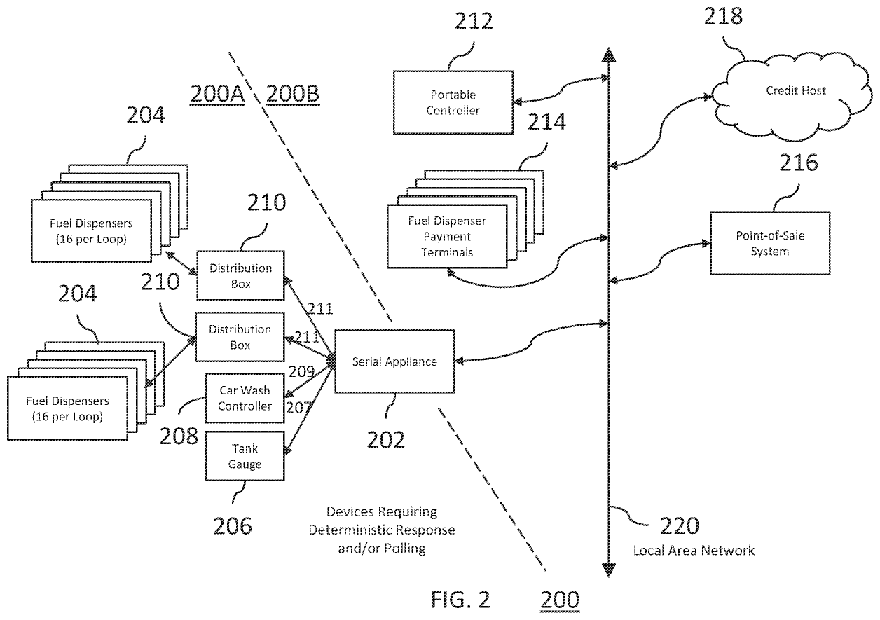

FIG. 2 is a block diagram of a forecourt control system 200 according to one embodiment of the disclosure. At the heart of the forecourt control system 200 is a serial appliance 202 that bridges between (i) a deterministic, forecourt realm 200A containing a number of different serial, forecourt devices 204-208 and (ii) a non-deterministic, event-driven, network realm 200B containing a number of different network devices 212-218, including a portable controller 212. The term “bridge” refers to the function of translating between two different signaling protocols.

In this particular embodiment, the forecourt realm 200A includes up to 32 different fuel dispensers 204, a tank gauge 206, and a car wash controller 208, where each of two different distribution boxes 210 aggregates the signaling for up to 16 different fuel dispensers 204. In this embodiment, the serial appliance 202 has four serial interfaces by which the serial appliance 202 can communicate with up to four different serial devices, in this case, the tank gauge 206, the car wash controller 208, and the two distribution boxes 210. In one possible implementation, each distribution box 210 is a Gilbarco PA0260000020 Universal Distribution Box from Gilbarco Inc. of Greensboro, North Carolina, that communicates with the serial appliance 202 over an RS422 link 211; the car wash controller 208 communicates with the serial appliance 202 over an RS232 link 209; and the tank gauge 206 communicates with the serial appliance 202 over a link 207 that may be an RS232 link or a TCP/IP (i.e., Ethernet) link, depending on the type of tank gauge deployed. Note that, in other embodiments, the forecourt realm 200A may have a different set of forecourt devices including one or more price sign controllers. Furthermore, in other embodiments, the serial appliance 202 may have fewer or more than four ports with which to communicate with forecourt devices.

In the embodiment of FIG. 2, the network realm 200B includes the serial appliance 202, the portable controller 212, one or more dispenser payment terminals 214 for the different fuel dispensers 204, an (e.g., in-store) point-of-sale system 216, and a cloud-based credit host 218, all of which communicate over a local area network (LAN) 220 via TCP/IP signaling.

The serial appliance 202 functions as a master in a master-slave relationship with the serial forecourt devices 204-208 with the serial appliance 202 repeatedly polling the forecourt devices 204-208 and the forecourt devices 204-208 responding in a deterministic manner (i.e., within a predictable time period). The serial appliance 202 initiates communications and arbitrates the connections 207-211 with the forecourt devices 204-208 functioning as response-only devices. In this embodiment, the forecourt realm 200A has multiple buses or “loops” of forecourt devices, each of which is managed by the serial appliance 202 in real-time.

At the same time, in the network realm 200B, the portable controller 212 services the “command and control” aspects, essentially implementing the transaction steps and business rules associated with the commerce.

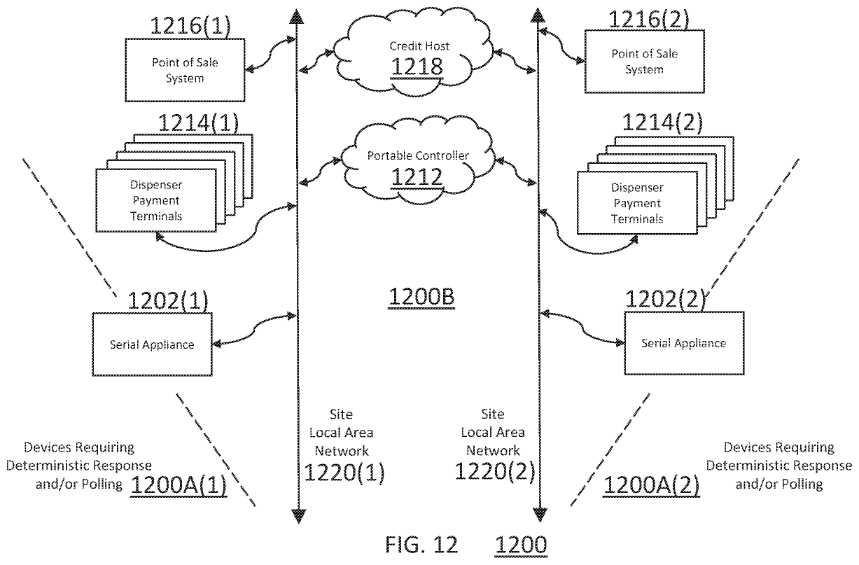

The portable controller 212 handles the TCP/IP communications to and from the payment terminals 214 since today's payment terminals tend to operate more in an event-driven or transactional mode rather than a poll/command/response mode. The migration of the payment terminals 214 to TCP/IP and the ability to decouple the serial interfaces from the command and control permits the higher-level function software of the portable controller 212 to be hosted locally on a typical business-class computing platform running Windows or Linux (as in FIG. 2) or hosted in the “cloud” (as shown, for example, in FIG. 12 described below).

At this same time, by offloading to the portable controller 212 the higher-level command and control processing as well as the TCP/IP connections to the point-of-sale, back office, and payment terminals, the serial appliance 202 can be scaled down to meet the needs of the application.

It is envisioned that the serial appliance 202 will be installed in close proximity to that of a traditional FCC and within the best-practice recommendations for serial communications equipment.

The serial appliance 202 supports configuration in two contexts: the forecourt realm 200A and the network realm 200B. The network configuration determines the route through which the portable controller 212 will access the other network devices. The forecourt configuration represents the forecourt devices with which the serial appliance 202 will communicate through the legacy serial interfaces.

Configuration data are conveyed to the serial appliance 202 through a well-defined interface and/or pre-loaded onto the forecourt device and persist in file form for recovery when re-started.

The serial appliance 202 takes the role of TCP/IP server nominally, listening for connections from the portable controller 212. The serial appliance 202 may also serve as a client to the portable controller 212.

The serial appliance 202 executes within a real-time multi-threaded environment addressing the need for deterministic response from the forecourt devices. Threads/processes may be assigned to a particular CPU core within the serial appliance 202 to optimize the overall system performance. The process of outward-facing communications with the portable controller 212 executes in its own CPU core, as do the processes that serve each (inward-facing) dispenser loop.

The novel, robust, and extensive Application Program Interface (API) between the portable controller 212 and the serial appliance 202 includes one or more of the following functionalities:
Device control—those functions that affect the overall operation of the serial appliance 202 such as stopping, starting, updating, and resetting the firmware, et cetera.
   Configuration—assigning network connection and hardware layout parameters.
   Error Event—unsolicited messages sent from the serial appliance 202 to the portable controller 212 indicating that an error has occurred.
   Heartbeat—a message sent periodically by either the serial appliance 202 or the portable controller 212 which provides confirmation of a network connection.
   License—a means to convey an operating license onto the serial appliance 202, without which a forecourt device will not operate nominally.
   Reset—a means to cause the serial appliance operating system, and by extension the serial appliance firmware, to restart.
   Start—a means to cause explicitly one or more serial appliance internal processes (threads) to begin operating.
   Stop—a means to cause explicitly one or more serial appliance internal processes (threads) to cease operating in an orderly manner.
Dispenser—those functions associated with fuel dispenser 204 operation and control.
   Configuration—the assignment of operating parameters such as product-to-hose mapping, model of the fuel dispenser 204 (for behavioral control), et cetera.
   Device Capabilities—a means to retrieve specific functional behavior information based on the configuration of the fuel dispenser 204. This allows the portable controller 212 to operate without specific knowledge of the inner workings of the fuel dispenser 204.
   Error Event—a means to convey to the portable controller 212 in an unsolicited message any errors encountered with a fuel dispenser 204.
   Method of Payment—a means for the portable controller 212 to specify the method of payment selected since this datum can originate in the fuel dispenser 204 or in the associated dispenser payment terminal 214.
   Presets—The maximum amount of fuel that may be dispensed specified by volume or dollar amount.
   Prices—The price to be charged for the various products dispensed. Pricing may be sent at startup (nominal price) and as a part of a sale (discounted price).
   Query—a means to interrogate the fuel dispenser 204 for device-specific information on an exceptional basis.
   Resume—a means to resume the dispensing of fuel after a transaction has been suspended.
   State—a means to read the operational state of the fuel dispenser 204 for startup synchronization et cetera.
   State Changed Event—a means for the serial appliance 202 to report operational state transitions to the portable controller 212 on an unsolicited basis.
   Start—a means to authorize the fuel dispenser 204 to dispense up to a preset amount of fuel based on volume or dollar amount.
   Stop—a means to halt the flow of fuel and ending an authorized transaction.
   Suspend—a means to halt the flow of fuel temporarily without ending the current transaction.
   Totals—a means to capture the cumulative (grand) total of product(s) dispensed.
   Transaction Data—a means to capture the post-sale information such as total volume dispensed, sale amount, price, method of payment, et cetera.
Car Wash—those items associated with interfacing with a car wash controller 208.
   Access Code—acquire from the car wash controller 208 an access code based on selections made through a dispenser payment terminal 214.
   Cancel Code—return to the car wash controller 208 a previously acquired but unused access code (if required by the car wash controller 208).
Tank Gauge—those items associated with interfacing to the automatic tank gauge 206.
   Start Event—a command to notify explicitly the tank gauge 206 that a sale has started.
   Stop Event—a command to notify explicitly the tank gauge 206 that a sale has ended.
   Pass Through—a means to send and receive commands directly with the tank gauge 206 using its native protocol.
Fuel Price Sign—those items associated with interfacing to the fuel price sign controllers (not part of the embodiment of FIG. 2).
   Read Price—a command to read programmed prices from the sign (if supported) or from the internal database of the serial appliance 202 (if not).
   Write Price—a command to send prices to the price sign.

The API between the serial appliance 202 and the portable controller 212 operates nominally in the mode of command/response and exceptionally when an event happens that necessitates raising an event notification message, e.g., fuel dispenser state change, device offline, et cetera.

The API may be implemented using any of the following or similar serialization schemes: Extensible Markup Language (XML), Java Script Object Notation (JSON), ASN.1 Encoding Rules (X.690), et cetera. For example, the portable controller 212 may convey a discounted price to fuel dispenser number two with an XML message of the form <Dispenser Id=“2”><Price Grade=“Regular”>$2.539</Price></Dis>

The structural organization of the API is well suited to deployment using one or more of the above-mentioned languages. For example, a root tag such as <SerialAppliance> might encapsulate tags representing the various functional groups of <Device>, <Dispenser>, <CarWash>, <TankGauge>, and <FuelPriceSign>.

Messages traversing between the portable controller 212 and the serial appliance 202 are well defined. To this end, the set of messages will be validated against a schema during the program design phase and as they are parsed by the serial appliance 202 and the portable controller 212. Malformed or erroneous messages will result in either an error response or error event being raised by the serial appliance 202.

The API can be obfuscated, or the TCP/IP stream can be enciphered using Transport Layer Security (TLS) so that the protocol cannot be easily reverse engineered. Multi-step operations such as authorizing the fuel dispenser 204 are divided between the portable controller 212 and the serial appliance 202. For example, authorization has two meanings: (i) to the serial appliance 202, authorization is a command sent to a fuel dispenser 204 that allows fuel to be dispensed and (ii) to the portable controller 212, authorization means one or more of the following: to select the method of payment, select the grade of fuel, determine the maximum amount that can be dispensed, apply a discount if applicable, and then finally send the authorization to the fuel dispenser 204. The portable controller 212 will coordinate the high-level transaction steps, and the serial appliance 202 will act as an “end-effector” to execute individual commands.

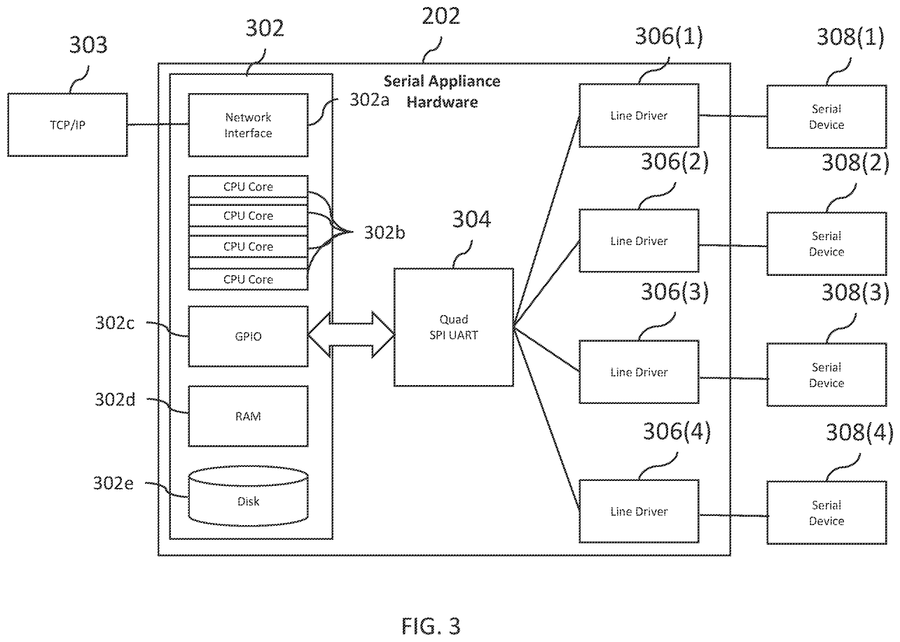

FIG. 3 is a hardware block diagram of the serial appliance 202 of FIG. 2 according to one possible implementation. The serial appliance 202 has an embedded compute platform 302, such as a Raspberry Pi, having a network interface 302a for communicating via TCP/IP signaling 303 with network devices on the LAN 220 of FIG. 2, a number of central processing unit (CPU) cores 302b, a general-purpose input/output (GPIO) interface 302c for communicating with a quad serial peripheral interface (SPI) universal asynchronous receiver transmitter (UART) module 304, random access memory (RAM) 302d, and a hard drive 302e. In this implementation of the serial appliance 202, the quad SPI UART module 304 supports four serial line drivers 306(1)-306(4) that enable the serial appliance 202 to communicate with up to four serial forecourt devices 308(1)-(308(4), such as devices 206-210 of FIG. 2.

The functionality of the serial appliance 202 transcends that of a conventional interface bridge to encompass aggregation of multiple slave devices as a master and, at the same time, segregates time-sensitive polling. This facilitates decoupling the command-and-control functionality from the immediate location of the forecourt devices requiring deterministic response. Typical state-of-the-art interface bridging devices contain general-purpose firmware that conveys the messages typically frame-by-frame albeit with appropriate buffering to accommodate the higher bandwidth of the TCP/IP side.

Given this architecture and the resources available in the embedded compute platform 302, the serial appliance 202 can be adapted readily to accommodate virtually any slave device nominally controlled through a user interface panel or remotely through a dumb terminal, emulator, or similar device driver within an automation controller. The serial appliance 202 might be deployed to monitor and/or control security/fire/safety systems, physical access to spaces, environment (HVAC control), energy usage, vending machines, et cetera.

The serial appliance 202 is aware (i.e., gnostic) of the specific protocols of the different forecourt devices. By bridging between the specific protocols of the deterministic forecourt realm 200A and the API of the non-deterministic, event-driven network realm 200B, the serial appliance 202 enables the portable controller 212 to be unaware (i.e., agnostic) of those specific protocols.

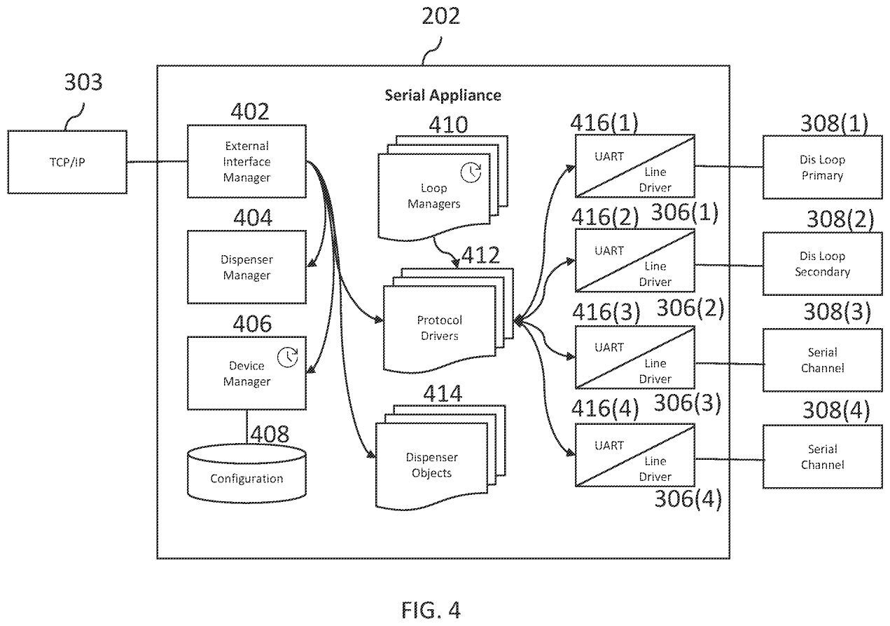

FIG. 4 illustrates the overall functional architecture of the serial appliance 202 of FIG. 2. As shown in FIG. 4, the serial appliance 202 has (i) an external interface manager 402 by which the serial appliance 202 communicates via TCP/IP signaling 303 with the portable controller 212 and other network devices of the LAN 220 in the network realm 200B of the forecourt control system 200 of FIG. 2 and (ii) four line drivers 306(1)-306(4) by which the serial appliance 202 communicates with up to four different forecourt devices 308(1)-308(4). In one particular configuration, the forecourt devices 308(1) and 308(2) of FIG. 4 may be the two distribution boxes 210 of FIG. 2, while the forecourt devices 308(3) and 308(4) of FIG. 4 may be the tank gauge 206 and the car wash controller 208 of FIG. 2.

TCP/IP message traffic 303 from the portable controller 212 is received by the external interface manager 402, which determines the subsystems within the serial appliance 202 to which the messages apply and routes them accordingly.

Messages associated with the configuration and management of the serial appliance 202 are handled by the device manager 406, which is also responsible for monitoring the heartbeat between the serial appliance 202 and the portable controller 212.

Messages associated with the fuel dispensers 204 are routed to the dispenser manager 404 for subsequent routing to the appropriate dispenser object 414 which then assumes overall responsibility for the disposition of the command. Since there are multiple fuel dispensers 204 on each loop, there exists, for each loop, a loop manager 410 to conduct the message traffic through the protocol drivers 412.

Messages associated with other forecourt devices (such as the tank gauge 206 and the car wash controller 208 of FIG. 2) that operate on a one-to-one basis with the serial appliance 202 are routed directly to the appropriate protocol driver 412.

The protocol drivers 412 provide a unified, agnostic interface to the loop managers 410 and the external interface manager 402. This permits the serial appliance 202 to manage any forecourt device regardless of model or manufacturer.

The protocol drivers 412 assemble outbound and parse inbound messages. Their outbound interfaces are to the individual UARTs elements 416(1)-416(4) of the quad SPI UART module 304. Each UART element 416 serializes and deserializes the bytes into frames and clocks the data out to the corresponding forecourt device through the appropriate line driver 306—which is typically an RS-232, RS-485, RS-422, or 45 mA current loop.

Line drivers 306(1)-306(4) provide the physical interfaces to the forecourt devices. To interface to the multiple fuel dispensers 204, “distribution boxes” 210 are used to “fan out” electrically the signals. In at least one implementation, the maximum number of fuel dispensers 204 that can be supported per loop is 16 and the maximum number of loops that can be supported by the serial appliance 202 is three for a maximum total number of fuel dispensers 204 per serial appliance 202 of 48. Within a given configuration, fuel dispensers 204 are assigned a logical identification number from 01 to 48 as well as a loop designation of 01 (primary), 02 (secondary), or 03 (tertiary). These data are maintained in a memory-resident table correlating dispenser ID and loop designation to control polling and to route the messages/responses to the appropriate dispenser object 414. Other, one-to-one forecourt devices simply connect directly to the corresponding serial appliance port. Each distribution box 210 may be viewed as a hub, serving multiple fuel dispensers 204 (or serial payment terminals) arranged typically in a star topology. While the distribution boxes 210 function as “fan out” devices, they still present an outward-facing physical serial interface to the serial appliance 202.

In the implementation of FIG. 3, the serial appliance modules 402-414 of FIG. 4 are implemented in software/firmware by the CPU cores 302b of the compute platform 302.

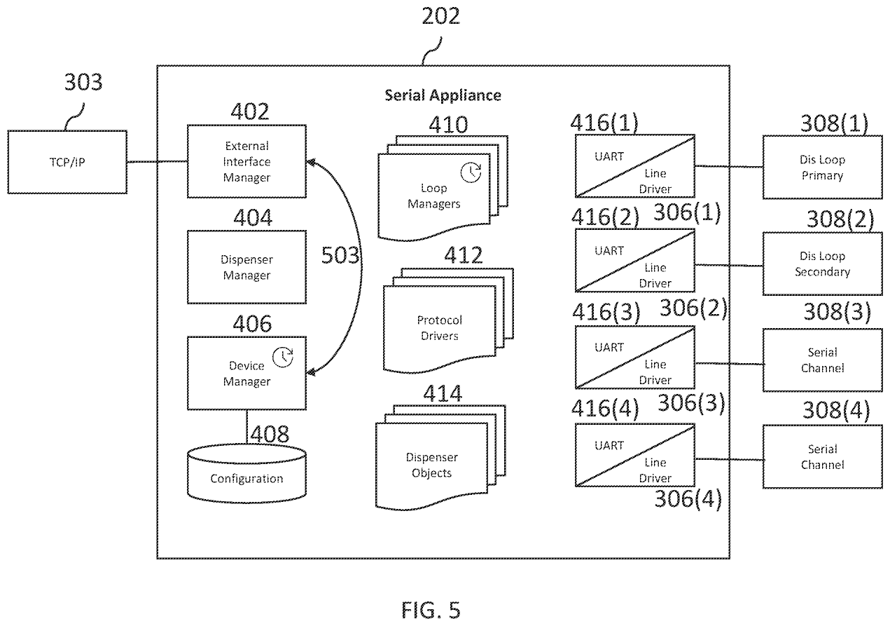

FIG. 5 illustrates the handling of device-specific messages. The device manager 406 receives all messages 503 associated with the control and configuration of each forecourt device. Device-specific messages 503 include configuration, error event reporting, heartbeat, device control (start/stop/reset), and enforcement of licensure. The resulting configuration data are persisted to local storage media in files as depicted by the configuration disk symbol C20.

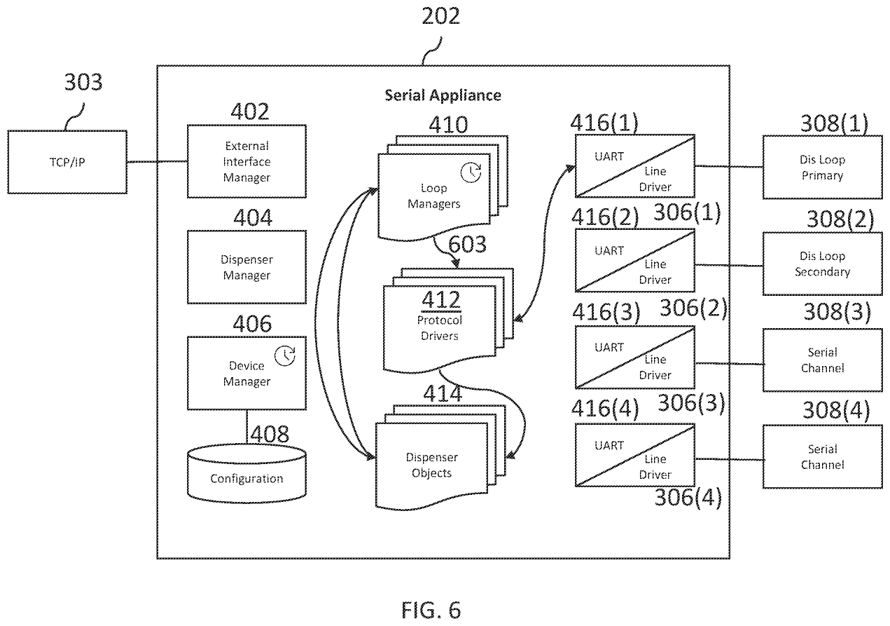

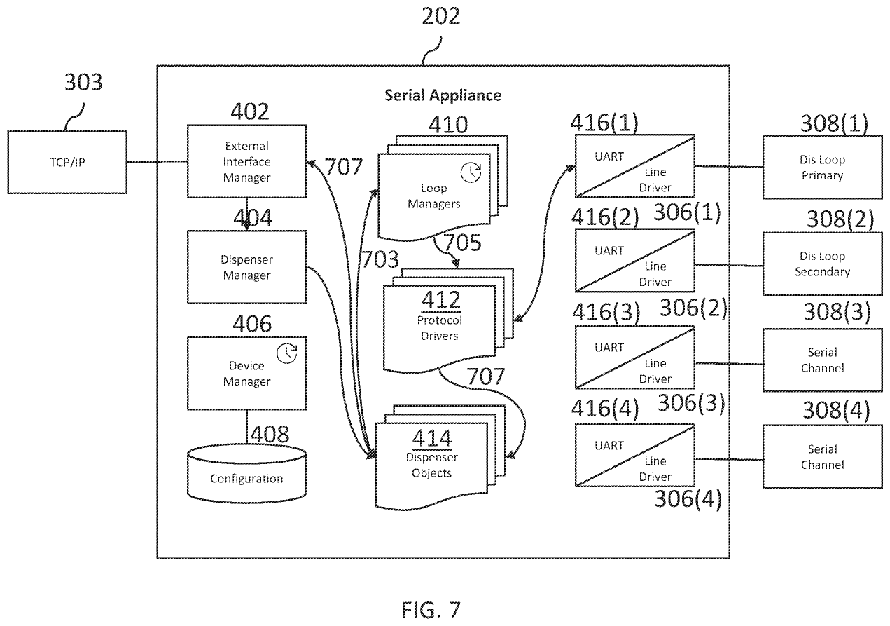

Fuel dispensers require periodic polling which necessitates handling requests from and routing responses to two sources: the respective loop manager 410 (polls) and the dispenser manager 404 through the appropriate dispenser object 414. FIG. 6 illustrates the path of poll messages, and FIG. 7 illustrates the path of messages received from the portable controller 212.

FIG. 6 illustrates the polling of the fuel dispensers 204. The loop managers 410 represent the interfaces between the dispenser objects 414 and the protocol drivers 412. Each loop manager 410 acts as the arbitrator of messages 603 to the corresponding protocol driver 110. When not handling an external request from the portable controller 212, the loop manager 410 will ensure that the fuel dispensers 204 on its loop are polled on a periodic basis. The loop manager 410 signals a dispenser object 414 that it is due to be polled. The dispenser object 414 creates a poll message and then signals the loop manager 410 that an outgoing message must be sent. The loop manager 410 then forwards the message request to the corresponding protocol driver 412 via path 603. On receipt, the protocol driver 412 will pass the result to the corresponding dispenser object 414, which can then take any appropriate action such as updating internal data or raising an event through the external interface manager 402.

FIG. 7 illustrates the processing of a dispenser command. Dispenser commands received through the external interface manager 402 from the portable controller 212 are routed to the dispenser manager 404, which routes the commands to the appropriate dispenser objects 414. The dispenser objects 414 then create the protocol-specific request messages 703 and then post the messages to the message queue object of the appropriate loop manager 410. The loop manager 410, receiving a message 703, sends the message 705 to the protocol driver 412, which sends the message 707 to the physical fuel dispenser 204 and awaits a response. After receiving the message 705, the protocol driver 412 parses and checks the message 705 for validity and then passes the response 707 to the dispenser object 414. The dispenser object 414 processes the response 707 and then either replies to the external interface manager 102 or cues additional messages as necessary.

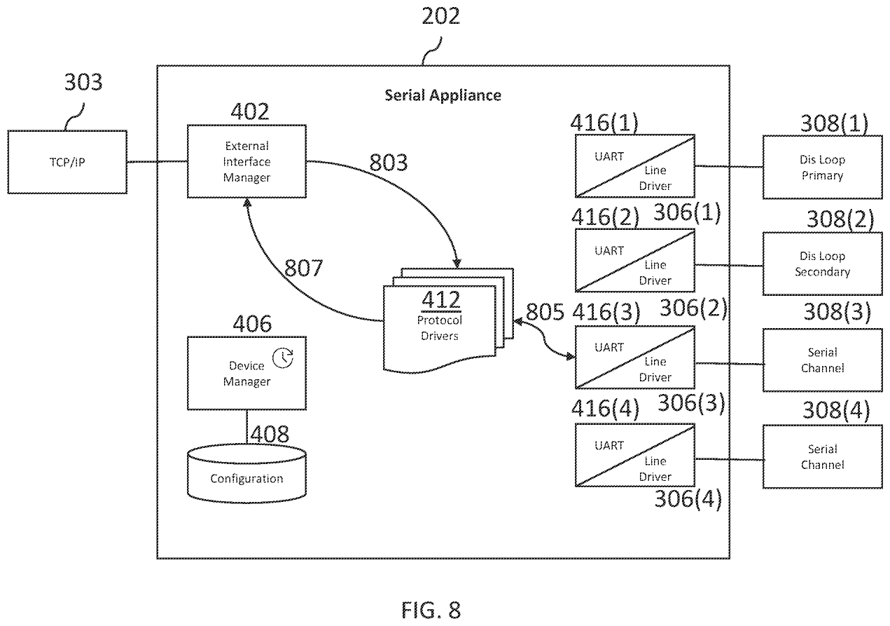

FIG. 8 illustrates the processing of commands for forecourt devices other than fuel dispensers 204. Forecourt devices other than fuel dispensers 204 have typically a one-to-one relationship with a serial port of the serial appliance 202 and include price sign controllers, car wash controllers, and automatic tank gauges. Commands 803 associated with these forecourt devices are received by the external interface manager 402 from the portable controller 212 and routed directly to the appropriate protocol driver 412. The protocol driver 412 can then build the appropriate command 803 and then access directly the UART element 416 to send the command 803. On receipt, the protocol driver 412 can construct an appropriate response 807 and then forward the response 807 to the external interface manager 402 for conveyance to the portable controller 212.

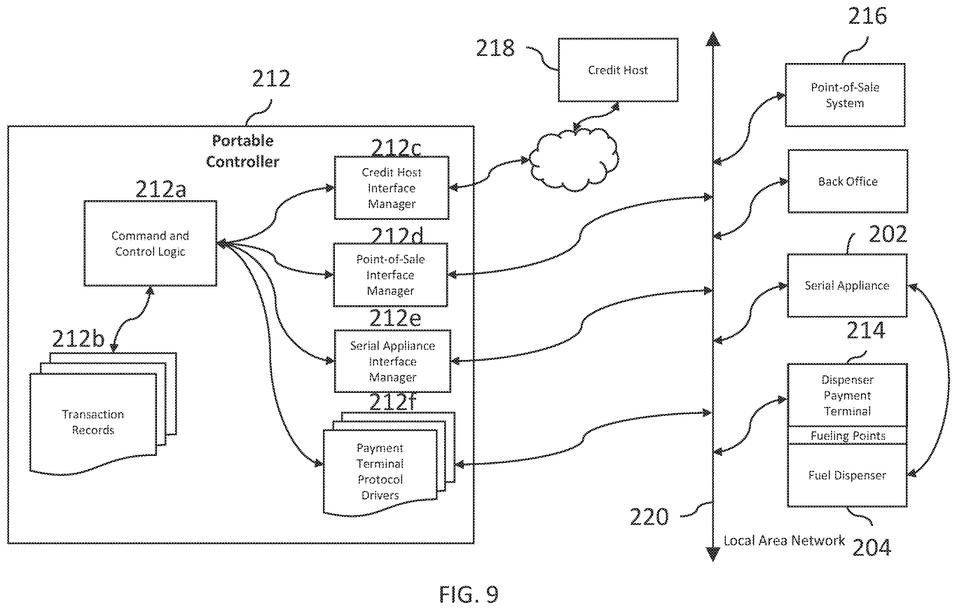

FIG. 9 illustrates a deployment of the portable controller 212 and serial appliance 202 in which the portable controller 212 is hosted on a computer housed locally—i.e., attached through a physical connection to the local area network 220.

Within the portable controller 212, the “command and control logic” element 212a represents the nominal application-related functions associated with a conventional forecourt controller. This functionality includes, but is not limited to, control of the payment terminal display, keypad, card reader, contactless reader, barcode reader, printer, et cetera. The “command and control logic” element 212a also orchestrates the transaction flow as the sale progresses, maintaining the state of each transaction within an array of transaction records 212b.

The “command and control logic” element 212a communicates point-of-sale-related data through the “point-of-sale interface manager” 212d. For example, when data are required of the customer, the payment terminal 214 is directed to acquire the data and then the data is conveyed to the point-of-sale system 216 through the “point-of-sale interface manager” 212d. The point-of-sale system 216 may also be used as a gateway to the (cloud-based) credit host 218 or other automata providing services such as customer loyalty, mobile payments, et cetera via the credit host interface manager 212c.

In some implementations, the “point-of-sale interface manager” 212d employs the Allied Network Dispenser Interface (ANDI) protocol by default and will be able to support other protocols such as the Conexxus IFSF Part 3-70 as required.

In conventional implementations, the FCC analog to the “command and control logic” element 212a communicated directly with a protocol driver associated with fuel dispensers. According to certain embodiments of the disclosure, the “command and control logic” element 212a conveys high-level dispenser-control commands through the “serial appliance interface manager” 212e to the serial appliance 202 attached to the local area network 220.

The array of “payment terminal protocol drivers” 212f essentially remains the same as that found in conventional forecourt controllers since the underlying mode of communications is unchanged.

Although the portable controller 212 in FIG. 2 is a local network device on the LAN 220, in other forecourt control systems of the disclosure, the portable controller may be implemented as a remote, cloud-based network device.

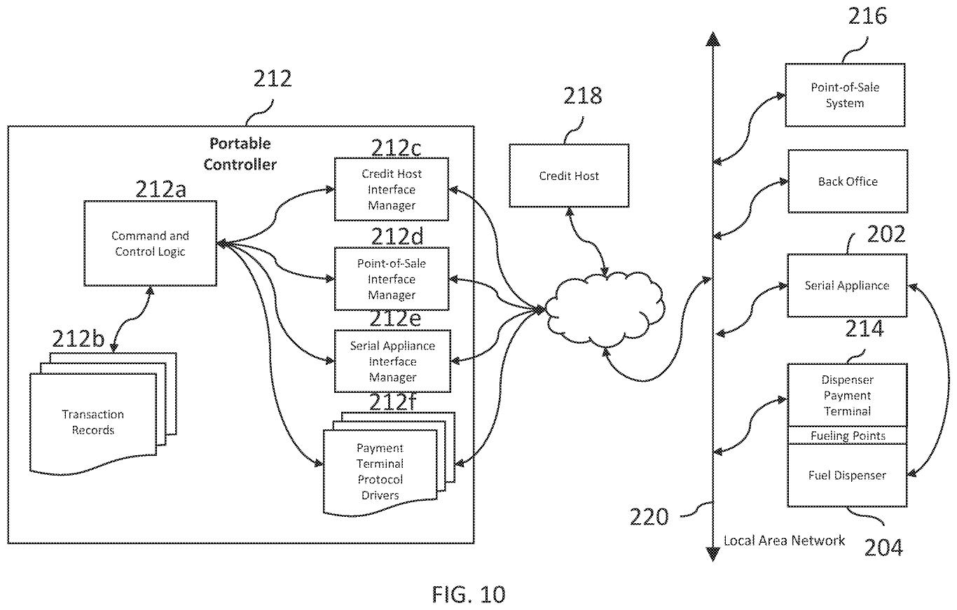

FIG. 10 illustrates a deployment of the portable controller 212 as hosted in the “cloud”. This deployment is functionally the same as the configuration depicted in FIG. 9; the difference being that the portable controller 212 software may execute remotely or may be further divided into multiple processes hosted on separate, even dissimilar platforms (i.e., a combination of Windows and Linux).

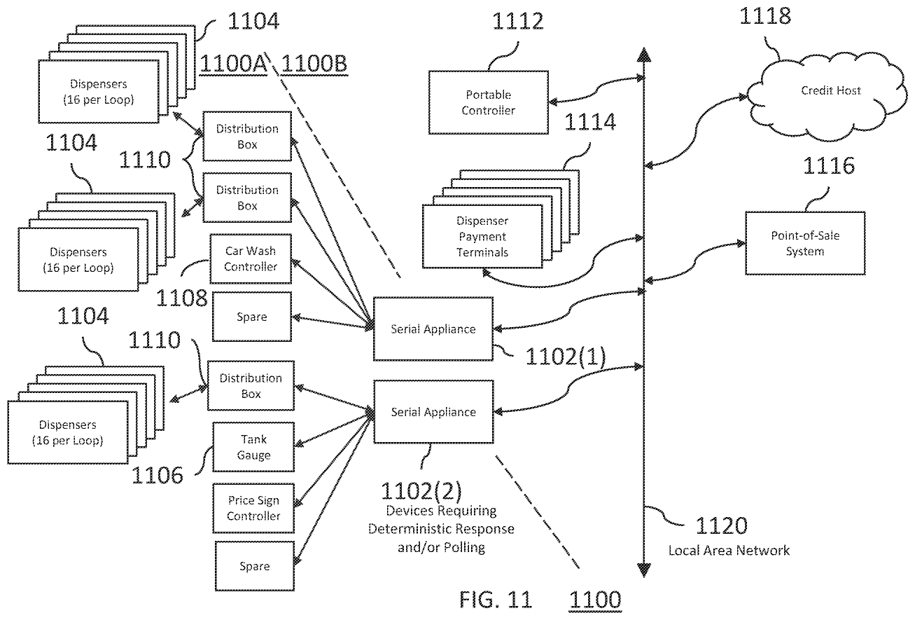

FIG. 11 is a block diagram of a forecourt control system 1100 according to an alternative embodiment of the disclosure. The forecourt control system 1100 is similar to the forecourt control system 200 of FIG. 2 with analogous elements having analogous labels. The main difference between the two forecourt control systems is that the forecourt control system 1100 has two serial appliances 1102(1) and 1102(2), where each serial appliance 1102 is responsible for a different subset of the forecourt devices in the forecourt realm 1100A. Note that the single portable controller 1112 in the network realm 1100B is capable of managing all of the forecourt devices via the two serial appliances 1102.

In general, a portable controller of the disclosure, which may be a local network device or cloud-based, is capable of managing the forecourt devices associated with one or more serial appliances of the disclosure, where those serial appliances may be co-located or remotely located from each other as long as each serial appliance is co-located with its associated forecourt devices.

FIG. 12 is a block diagram of a forecourt control system 1200 according to another alternative embodiment of the disclosure. The forecourt control system 1200 is similar to the forecourt control system 1100 of FIG. 11 with analogous elements having analogous labels. The main difference between the two forecourt control systems is that, in the forecourt control system 1200, the two serial appliances 1202(1) and 1202(2) are remotely located from one another with a single cloud-based portable controller 1212 communicating with both serial appliances 1202(1) and 1202(2) via respective LANs 1220(1) and 1220(2). As shown in FIG. 12, the first serial appliance 1202(1) manages a first set of forecourt devices (not explicitly shown) in a first forecourt realm 1200A(1), while the second serial appliance 1202(2) manages a second set of forecourt devices (not explicitly shown) in a second forecourt realm 1200A(2), with the portable controller 1212 being part of a single network realm 1200B consisting of the two LANs 1220(1) and 1220(2) and the two sets of associated network devices, such as the two point-of-sale systems 1216(1) and 1216(2) and the two sets of dispenser payment terminals 1214(1) and 1214(2) which are respectively co-located with the two serial appliances 1202(1) and 1202(2). In this way, a single portable controller 1212 can control the operations of multiple, remotely located gas stations.

Embodiments of this disclosure may provide one or more the following features:
Decoupling of the strict real-time processing requirements, which permits the “command and control” actions to be hosted on common business-class computing platforms, virtual servers, or “cloud-based” systems.
Separation of the commercial transaction state and the physical state of the automation equipment.
Implementation of the serial appliance as a single device scaled appropriately in terms of computing power and I/O resources providing manufacturer—and model—independent support for forecourt peripherals accessible from a single TCP/IP address/port.
Integration of the serial appliance 202 directly into a fuel dispenser 204, dispenser/payment terminal 2-wire distribution box 210, or other forecourt devices providing a TCP/IP interface.
Reduced recovery time from system/peripheral faults since the sophisticated transaction data are kept in the portable controller 212 rather than in the serial appliance.
Increased data security since the physical hardware interfacing to the fuel dispensers 204 need no longer contain any cardholder data.
Deployment of equipment supplied by different manufacturers at the same site, facilitating life extension of legacy fuel dispensers 204 as well as integration of dissimilar equipment acquired through merger, acquisition, et cetera.

In some embodiments, a system comprises a serial appliance comprising one or more first interfaces configured to support deterministic communications with one or more deterministic devices using one or more specific device protocols; at least one second interface configured to support event-driven communications with one or more event-driven devices that are agnostic of the one or more specific device protocols; and at least one processor configured to bridge the deterministic and event-driven communications.

In at least some of the above embodiments, the one or more event-driven devices comprises a portable controller; and the serial appliance is configured to enable the portable controller to control the one or more deterministic devices at a logical level by converting device-agnostic event-driven communications from the portable controller into device-gnostic deterministic communications with the one or more deterministic devices.

In at least some of the above embodiments, the system further comprises the portable controller.

In at least some of the above embodiments, each deterministic device is a deterministic forecourt device. The one or more deterministic forecourt devices comprise at least one of one or more fuel dispensers, a car wash controller, a tank gauge, and a price sign controller, and the one or more event-driven devices further comprise at least one of one or more dispenser payment terminals, a point-of-sale system, and a cloud-based credit host.

In at least some of the above embodiments, the system further comprises the one or more deterministic forecourt devices and the one or more event-driven devices.

In at least some of the above embodiments, the system further comprises one or more distribution boxes, each distribution box providing an aggregation function for multiple fuel dispensers.

In at least some of the above embodiments, the system further comprises one or more additional serial appliances, each additional serial appliance configured to bridge the portable controller and one or more additional deterministic forecourt devices.

In at least some of the above embodiments, at least two of the serial appliances are remotely located from each other.

In at least some of the above embodiments, the serial appliance is configured to communicate with one or more event-driven devices via a local area network.

In at least some of the above embodiments, at least one first interface is a serial line driver, and the at least one second interface is a TCP/IP network interface.

Unless explicitly stated otherwise, each numerical value and range should be interpreted as being approximate as if the word “about” or “approximately” preceded the value or range.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred—to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “managers” and/or “drivers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “manager” or “driver” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits.

The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A system comprising a serial appliance comprising:
one or more first interfaces configured to support deterministic communications with one or more deterministic devices using one or more specific device protocols;
at least one second interface configured to support event-driven communications with one or more event-driven devices that are agnostic of the one or more specific device protocols; and
at least one processor configured to bridge the deterministic and event-driven communications.

2. The system of claim 1, wherein:
the one or more event-driven devices comprises a portable controller; and
the serial appliance is configured to enable the portable controller to control the one or more deterministic devices at a logical level by converting device-agnostic event-driven communications from the portable controller into device-gnostic deterministic communications with the one or more deterministic devices.

3. The system of claim 2, further comprising the portable controller.

4. The system of claim 2, wherein:
each deterministic device is a deterministic forecourt device;
the one or more deterministic forecourt devices comprise at least one of:
one or more fuel dispensers;
a car wash controller;
a tank gauge; and
a price sign controller; and
the one or more event-driven devices further comprise at least one of:
one or more dispenser payment terminals;
a point-of-sale system; and
a cloud-based credit host.

5. The system of claim 4, further comprising the one or more deterministic forecourt devices and the one or more event-driven devices.

6. The system of claim 5, further comprising one or more distribution boxes, each distribution box providing an aggregation function for multiple fuel dispensers.

7. The system of claim 5, further comprising one or more additional serial appliances, each additional serial appliance configured to bridge the portable controller and one or more additional deterministic forecourt devices.

8. The system of claim 7, wherein at least two of the serial appliances are remotely located from each other.

9. The system of claim 1, wherein the serial appliance is configured to communicate with the one or more event-driven devices via a local area network.

10. The system of claim 1, wherein:
at least one first interface is a serial line driver; and
the at least one second interface is a TCP/IP network interface.
